(19) United States
(12) Patent Application Publication
(10) Pub. No.: US 2015/0043219 A1
(43) Pub. Date: Feb. 12, 2015

(54) Blue light LED sensor lamp

(71) Applicant: Ningbo Weitao Electrical Appliance Co., Ltd., Ninghai (CN)

(72) Inventor: Jiangang DAI, Ninghai (CN)

(73) Assignee: Ningbo Weitao Electrical Appliance Co., Ltd., Ninghai (CN)

(21) Appl. No.: 13/962,992

(22) Filed: Aug. 9, 2013

(51) Int. Cl. F21K 99/00

(52) U.S. Cl. CPC F21K 9/30; F21K 9/50
USPC 362/311.02

(57) ABSTRACT

The present application is directed to a blue light LED sensor lamp, which possesses a lamp head and a lamp body that connects to the lamp head. The lamp body is formed from the fastening between a ship shaped bottom cap and a ship shaped flat cover. The lamp head is formed from the LED lamp, cylinder and lens embedded within the bottom cap. Within the lamp body is provided with a fixed support. On the fixed support is installed with a sensor PCB electric circuit board. On the PCB electric circuit board is provided with a sensor head base of the lens. The sensor lens protrudes the fixed support and extends outside the flat cover. Outside the lens is provided with a positioning cover that is installed from flat cover to the fixed support.

### FIELD OF THE TECHNOLOGY

The present application is directed to a lamp, specifically to a sensor lamp.

### BACKGROUND

Currently, a variety of sensor lamps exist, such as touch mode electric sensor lamp, light control sensor lamp, sound control sensor lamp, and component sensor lamp etc. As sensor lamps, the essential characteristics that should be possessed include: high sensitiveness, high resistance to interference and relatively low production cost. However, the currently available kinds of human sensor lamps all can hardly meet these criteria. For example, the touch mode electric sensor lamps have low sensitiveness, the light and sound control sensor lamps have poor resistance to interference. Further, their electric circuits are relatively complicated and render relatively higher in production costs.

Therefore, a sensor lamp with a simple structure, low production cost and better performance is necessary.

### SUMMARY

The purpose of the present application is to provide a human sensor lamp that is simple structured, inexpensive yet with good performance.

In order to achieve the above purpose, the technical solution that the present application applies is: a blue light LED sensor lamp, including a blue light LED sensor lamp, which possesses a lamp head and a lamp body that connects to the lamp head. The lamp body is formed from the fastening between a ship shaped bottom cap and a ship shaped flat cover. The lamp head is formed from the LED lamp, cylinder and lens that are embedded within the bottom cap. Within the lamp body is provided with a fixed support. On the fixed support is installed with a sensor PCB electric circuit board. On the PCB electric circuit board is provided with a sensor head base of the lens. The sensor lens protrudes the fixed support and extends outside the flat cover. Outside the lens is provided with a positioning cover that is installed from flat cover to the fixed support. The positioning cover extends outside part of the fixed support through a positioning circular piece for positioning. Between the flat cover and the fixed support is provided with an LED lamp band. On the PCB electric circuit board is further provided with a blue light LED lamp installed on the backlight board. The blue light LED lamp is electrically connected to the LED lamp band.

Further, the positioning cover includes a main body section situated outside the flat cover and a positioning section that is formed by extending downward from the main body section. The positioning section is provided with external spiral lines. On the positioning circular piece is provided with internal spiral lines that couples with the external spiral lines.

Further, the side face of the lamp body bottom cap is provided with light touch on/off switch. Outside the light touch on/off switch is provided with a press button for on/off control.

Further, the fixed support is installed on the lamp body bottom cap through spiral nails.

Further, near the front section of the lamp body is provided with a magnet. Near the rear section of the lamp body is provided with a lamp body line revolving circular piece. The line revolving circular piece is formed on a positioning pole on the fixed support. The magnet and the lamp body line revolving circular piece are situated at the two end of the same side of the PCB electric circuit board, respectively.

Further, the sensor lamp can be recharged through the socket.

Further, the socket includes a top cap and a bottom cap that fasten together, a power charging line revolving circular piece situated within the top cap and the bottom cap, a power charging PCB electric circuit board and a metal board that electrically connect to the power charging line revolving circular piece, and a plug cover and a plug base that are installed on the power charging PCB electric circuit board. On the plug base is provided with plug-in piece. The plug cover and plug base are fixed through spiral nails.

Further, the top cap and bottom cap are fixedly installed through spiral nails.

In comparing the blue light LED sensor lamp of the present application with prior arts, the following beneficial results are possessed: Through the electrical connection between the sensor line circular piece and the sensor lens by the PCB electric circuit board, the structure of the blue light LED sensor lamp can be simplified. At the same time, the sensitiveness of the blue light LED sensor lamp can be raised, while the use is convenient.

### BRIEF DESCRIPTION OF THE DRAWINGS

FIG. 1 is an assemblage cross sectional view of the present application.

FIG. 2 is a three dimensional dissection view of the present application.

FIG. 3 is an assemblage cross sectional view of a corresponding socket of the present application.

FIG. 4 is a three dimensional dissection view of the corresponding socket of the present application.

### DETAILED DESCRIPTION

Below is a further description of the present application in combination with the drawings.

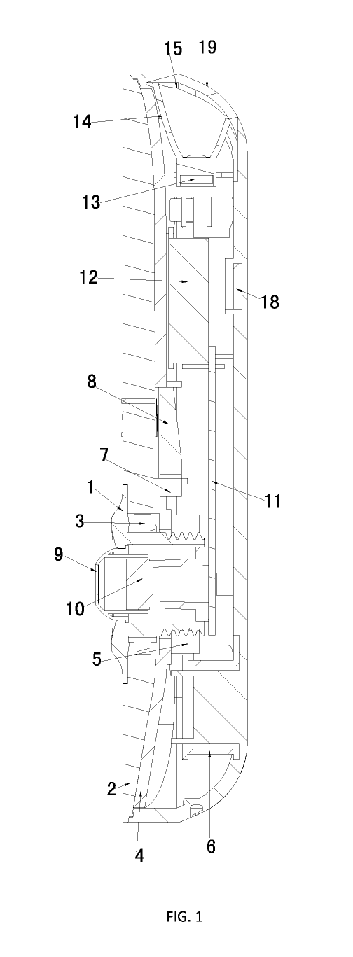

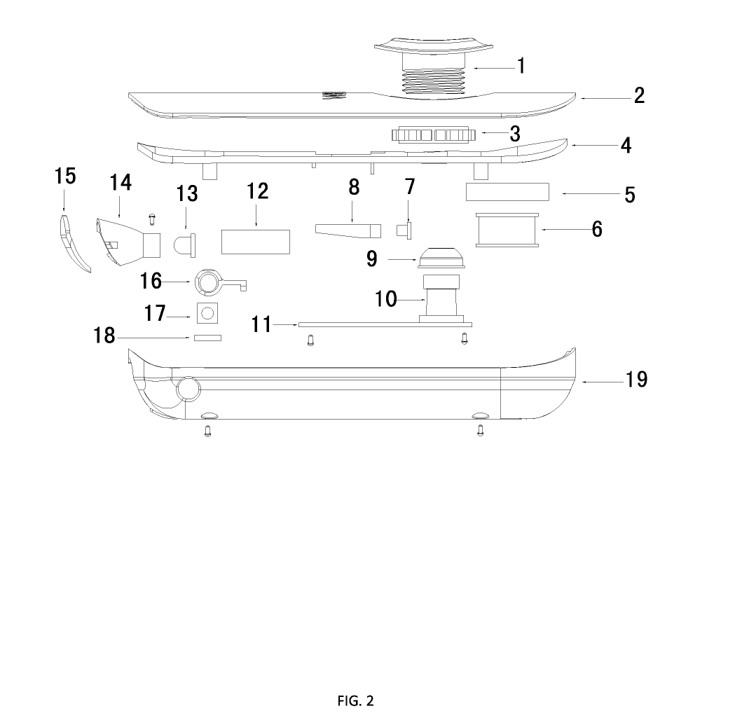

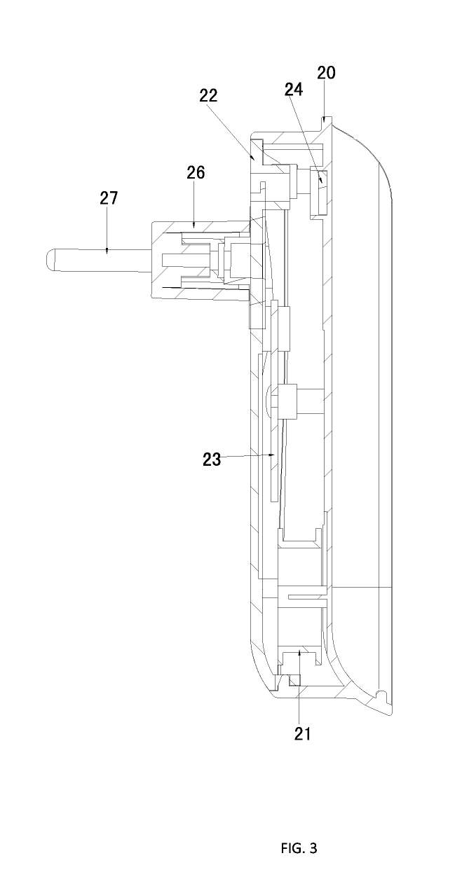

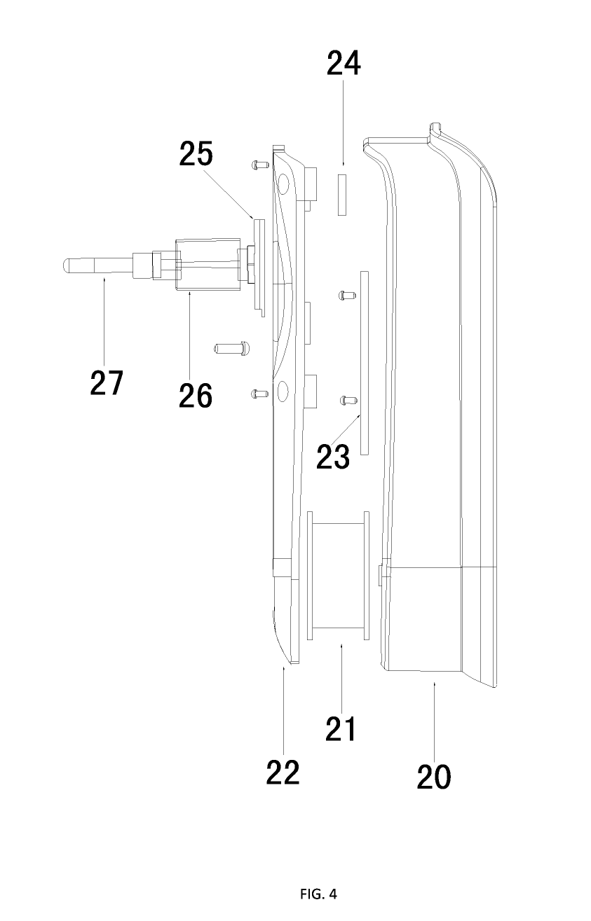

Referring to FIGS. 1 to 4, they are a blue light LED sensor lamp of the present application. It includes a lamp head and a lamp body that connects to the lamp head. The lamp body is formed from the fastening between a ship shaped bottom cap 19 and a ship shaped flat cover 2. The lamp head is formed from the LED lamp 13, cylinder 14 and lens 15 that are embedded within the bottom cap 19. Within the lamp body is provided with a fixed support 4. On the fixed support 4 is installed with a sensor PCB electric circuit board 11. On the PCB electric circuit board 11 is provided with a sensor head base 10 of the lens 9. The sensor lens 9 protrudes the fixed support 4 and extends outside the flat cover 2. Outside the lens 9 is provided with a positioning cover 1 that is installed from flat cover 2 to the fixed support 4. The positioning cover 1 extends outside part of the fixed support 4 through a positioning circular piece 5 for positioning. Between the flat cover 2 and the fixed support 4 is provided with an LED lamp band 3. On the PCB electric circuit board 11 is further provided with a blue light LED lamp 7 installed on the backlight board 8. The blue light LED lamp 7 is electrically connected to the LED lamp band 3.

The positioning cover 1 includes a main body section situated outside the flat cover and a positioning section that is formed by extending downward from the main body section. The positioning section is provided with external spiral lines. On the positioning circular piece 5 is provided with internal spiral lines that couples with the external spiral lines.

The side face of the lamp body bottom cap 19 is provided with light touch on/off switch 17. Outside the light touch on/off switch is provided with a press button 16 for on/off control.

The fixed support 4 is installed on the lamp body bottom cap 19 through spiral nails.

Near the front section of the lamp body 19 is provided with a magnet 18. Near the rear section of the lamp body is provided with a lamp body line revolving circular piece 6. The line revolving circular piece is formed on a positioning pole on the fixed support. The magnet 18 and the lamp body line revolving circular piece 6 are situated at the two end of the same side of the PCB electric circuit board 11, respectively.

The sensor lamp can be recharged through the socket.

The socket includes a top cap 22 and a bottom cap 20 that fasten together, a power charging line revolving circular piece 21 situated within the top cap and the bottom cap, a power charging PCB electric circuit board 23 and a metal board 24 that electrically connect to the power charging line revolving circular piece, and a plug cover 25 that is installed on the power charging PCB electric circuit board 23. On the plug cover 25 is provided with plug-in piece 27.

The top cap and bottom cap are fixedly installed through spiral nails.

The hand held lamp in the blue light LED sensor lamp of the present application can be used as a hand held torch after detaching from the power charging base. The on/off switch turns on in the order of flat surface light, head light and power off.

When the lamp body is placed inside the power charging base on the power source socket that corresponds to the power charging socket, it can be used as a thermal infrared human sensor lamp under different situations, when body movement is detected in the sensor region then lamp is lighted. The lamp will be turned off automatically after a certain period of time. The sensor function can be turned on or off by pressing the on/off switch. In order to save the sensor effect of the product, the sensor lamp is ineffective at situation when a definite amount of light is already available, while it can be used only when the surrounding is dark without light.

If the situation of power shut down occurs when the lamp body is placed on the power charging base, the flat surface lamp will automatically lighten. At this time, one can select, by pressing the on/off switch, a flat surface light, head light, or power off.

The lamp body applies wireless method to realize the power charging function. By placing the lamp body into the power charging base that is above the power source socket which corresponds to the power charging socket, automatic power charging can be realized during situation other than power shut down. The interior is provided with complete power charging management and protection functions. Upon fully charging of the batteries the power charging function will be automatically turned off and does not require the user to take out the product. The structure of the present application is simple and is convenient to use.

1. A blue light LED sensor lamp, comprising a lamp head and a lamp body that connects to the lamp head with features: the lamp body is formed from the fastening between the ship shaped bottom cap and ship shaped flat cover, the lamp head is formed from the LED lamp, cylinder and lens embedded within the bottom cap, within the lamp body is provided with a fixed support; on the fixed support is installed with a sensor PCB electric circuit board; on the PCB electric circuit board is provided with a sensor head base of the lens; the sensor lens protrudes the fixed support and extends outside the flat cover; outside the lens is provided with a positioning cover that is installed from flat cover to the fixed support; the positioning cover extends outside part of the fixed support through a positioning circular piece for positioning; between the flat cover and the fixed support is provided with an LED lamp band; on the PCB electric circuit board is further provided with a blue light LED lamp installed on the backlight board; the blue light LED lamp is electrically connected to the LED lamp band.

2. The blue light LED sensor lamp according to claim 1, whose feature lies in: the positioning cover includes a main body section situated outside the flat cover and a positioning section that is formed by extending downward from the main body section; the positioning section is provided with external spiral lines; on the positioning circular piece 5 is provided with internal spiral lines that couples with the external spiral lines.

3. The blue light LED sensor lamp according to claim 2, whose feature lies in: the side face of the lamp body bottom cap is provided with a light touch on/off switch; outside the light touch on/off switch is provided with a press button for on/off control.

4. The blue light LED sensor lamp according to claim 3, whose feature lies in: the fixed support is installed on the lamp body bottom cap through spiral nails.

5. The blue light LED sensor lamp according to claim 4, whose feature lies in: near the front section of the lamp body is provided with a magnet; Near the rear section of the lamp body is provided with a lamp body line revolving circular piece; the magnet and the lamp body line revolving circular piece 6 are situated at the two end of the same side of the PCB electric circuit board, respectively.

6. The blue light LED sensor lamp according to claim 5, whose feature lies in: the sensor lamp can be recharged through the socket.

7. The blue light LED sensor lamp according to claim 6, whose feature lies in: the socket includes a top cap and a bottom cap that fasten together, a power charging line revolving circular piece situated within the top cap and the bottom cap, a power charging PCB electric circuit board and a metal board that electrically connect to the power charging line revolving circular piece, and a plug cover that is installed on the power charging PCB electric circuit board; on the plug cover is provided with a plug-in piece.

8. The blue light LED sensor lamp according to claim 7, whose feature lies in: the top cap and bottom cap are fixedly installed through spiral nails.
